(19) United States
(12) Patent Application Publication
(10) Pub. No.: US 2026/0216734 A1
(43) Pub. Date: Jul. 30, 2026

(54) CONTINUOUS MECHANICAL SHREDDING APPARATUS AND RELATED CONTROL METHOD

(71) Applicant: POLITECNICO DI MILANO, Milano (IT)

(72) Inventors: Marco Diani, Cardano al Campo (VA) (IT); Marcello Colledani, Milano (IT); Davide Delfrate, Rozzano (MI) (IT)

(73) Assignee: POLITECNICO DI MILANO, Milano (IT)

(21) Appl. No.: 19/142,060

(22) PCT Filed: Dec. 6, 2023
(86) PCT No.: PCT/EP2023/084469

§ 371 Date: Jun. 20, 2025

(30) Foreign Application Priority Data
Dec. 20, 2022 (IT) 102022000026121

(51) Int. Cl. B02C 25/00

(52) U.S. Cl. CPC B02C 25/00

(57) ABSTRACT

A continuous mechanical shredding apparatus, comprising: a first transportation system (10) of input material (710); a first data acquisition system (20) for the input material (710); a mechanical shredding system (30) to shred said input material (710); a control system (40); a second transportation system (50) of output material (720); a second data acquisition system (60) for the output material (720). The control system (40) receives at least one first dimension (810) of the input material (710) and at least one second dimension (820) of the output material (720). The control system (40) determines process parameters including: a speed of the first transportation system (10) to modify a flow rate (910) of the input material; at least one dimensional parameter (930) of a regulation device (35); at least one rotation speed (920). The control system (40) optimizes the process parameters according to a target for the at least one second dimension (820) of the output material (720). A control method of a continuous mechanical shredding apparatus.

### DESCRIPTION

### Technical Field

The present invention relates to a continuous mechanical shredding apparatus. The present invention relates to a control method of a continuous mechanical shredding apparatus.

The present invention finds application in mechanical shredding apparatuses, in particular the ones incorporating cyber-physical systems for the control of mechanical machining.

### Prior Art

A mechanical shredding process is a process through which the dimensions of a starting material, subjected to shredding, can be reduced. The shredded material, reduced to dimensions even smaller than 1 mm, may thus become a raw material for the production of manufactured articles.

Non-limiting examples of mechanical shredding machineries used for the reduction of the dimensions of an object are: sanders, chippers, granulators, and hammer mills.

Usually but without limitations, a mechanical shredding apparatus comprises a transportation system bringing the material to be shredded to the mechanical shredding machinery, one or more mechanical shredders, and, lastly, an area designated for the collection of shredded material.

Usually but without limitations, the mechanical shredding machineries have an inlet designated for the supply of the material to be shredded, sharp tools mounted on one or more rotors placed inside a shredding chamber and a system for letting the material exit that may be in free fall or through a grid for controlling the output dimension.

In a mechanical shredding machinery, shredding occurs, usually but without limitations, due to the impact and/or shearing force generated by the collision of the moving tools with the material inside the chamber and by the compression of the material between them and the walls of said chamber, during the movement due to the action of the moving tools.

The publication Diani M., Colledani M., Cyber-Physical Systems formalization in de- and remanufacturing and application to size reduction stage, Procedia CIRP Volume 91, 2020, Pages 741-746, https://doi.org/10.1016/j.procir.2020.03.117 relates to an architecture aimed at optimizing and controlling, among others, of a shredding process.

### SUMMARY OF THE INVENTION

An object of the present invention is to overcome drawbacks of the prior art.

A further particular object of the present invention is to provide a more effective continuous mechanical shredding apparatus.

A further particular object of the present invention is to control a continuous mechanical shredding apparatus in an improved manner.

A further particular object of the present invention is to provide a more accurate prediction of the dimensional characteristics of the shredded material exiting a continuous mechanical shredding apparatus.

A further particular object of the present invention is to provide a continuous mechanical shredding apparatus that allows a lower energy consumption, for a same quality of the shredded output material.

These and other objects are achieved by a continuous mechanical shredding apparatus and by a corresponding control method according to the features of the appended claims, which are integral part of the present description.

An idea underlying the present invention is to provide the control of the process parameters of a continuous mechanical shredding machinery. The proposed shredding system comprises one or more devices for the acquisition of dimensional data of objects, one or more mechanical shredders and a control system, in particular by means of software, to predict the dimensional distribution of the material exiting the shredder. The mechanical shredding apparatus uses an approach based on the demand of material within a required specification, to optimize the process of continuous mechanical shredding. In particular, the system for controlling the process of continuous mechanical shredding has a software including two modules for the optimization of the process parameters; the first module is designated for the optimization of the output dimensional distribution whereas the second module is designated for cost minimization, in particular for the minimization of wear and energy costs. The control of the shredding process may be carried out by means of a change of a dimensional grid, a change of shredding tools, an adjustment of the rotation speed of the shredding tools and a variation of the flow rate of the material put into the shredding chamber.

The invention provides a continuous mechanical shredding apparatus, comprising:
a first transportation system of input material, for a material to be shredded,
a first data acquisition system for the input material, configured to analyze at least one first dimension of the input material,
a mechanical shredding system comprising moving tools to shred the input material, and further comprising at least one regulation device configured to adjust a dimension of output particles from the mechanical shredding system,
a control system operatively associated with elements of the mechanical shredding apparatus,
a second transportation system of output material, for a material shredded by the mechanical shredding system,
a second data acquisition system for the output material, configured to analyze at least one second dimension of the output material.

The control system is configured to receive the at least one first dimension of the input material and the at least one second dimension of the output material.

The control system is configured to automatically determine process parameters including:
an operation speed of the first transportation system to modify a flow rate of the input material,
at least one dimensional parameter of the at least one regulation device,
at least one rotation speed of the moving tools.

The control system is adapted to optimize the process parameters according to a target for the at least one second dimension of the output material.

The invention provides a control method of a continuous mechanical shredding apparatus. Said continuous mechanical shredding apparatus comprises:
a first transportation system of input material, for a material to be shredded,
a first data acquisition system for the input material,
a mechanical shredding system comprising moving tools to shred the input material, and further comprising at least one regulation device configured to adjust a dimension of output particles from the mechanical shredding system,
a second transportation system of output material, for a material shredded by the mechanical shredding system,
a second data acquisition system for the output material.

The control method comprises:
analyzing at least one first dimension of the input material by the first data acquisition system,
analyzing at least one second dimension of the output material by the second data acquisition system,
determining process parameters including: an operation speed of the first transportation system to modify a flow rate of the input material; a dimensional parameter of the at least one regulation device; at least one rotation speed of the moving tools.

The control method provides the optimization of the process parameters according to a target for the at least one second dimension of the output material.

In general, the control method according to the invention is adapted to be provided in a continuous mechanical shredding apparatus according to the invention, in particular at least by the corresponding control system. Thus, the features described in connection with the first are applicable to the second, and vice versa.

Advantageously, the present invention allows to predict and optimize the dimensional distribution of the shredded output material.

Advantageously, the present invention allows to control the dimensional distribution of the shredded output material more accurately.

Advantageously, the present invention allows to minimize the energy consumption of a continuous mechanical shredding apparatus.

Advantageously, the present invention allows to minimize the wear of the shredding tools of a continuous mechanical shredding apparatus.

Preferably, the control system determines the process parameters according to a real-time training considering the at least one first dimension of the input material and the at least one second dimension of the output material.

Preferably, the control system comprises a database to store previously acquired historical data and comprises a data processing module that makes a data processing algorithm trained with the historical data.

Preferably, the control system comprises a feedback control module to further train the processing algorithm according to data collected in real time by the first data acquisition system and the second data acquisition system.

Preferably, the control system comprises an optimization module, to optimize the second dimension of the output material and further to minimize an energy requirement of the mechanical shredding system and wear of the moving tools.

Preferably, the control system adjusts the speed of the first transportation system, namely the flow rate of input material. Preferably, the control system adjusts the at least one dimensional parameter of the at least one regulation device, which influences the output dimension of the output material. Preferably, the control system adjusts the at least one rotation speed of the moving tools.

Preferably, the first data acquisition system and the second data acquisition system comprise at least one image acquisition system, which, through suitable algorithms, is capable of determining at least a dimensional distribution of a material framed in a respective acquired image.

Preferably, the first data acquisition system and the second data acquisition system are further capable of analyzing further morphological characteristics of the input material and of the output material, respectively. Preferably, said morphological characteristics include shape and/or sphericity and/or symmetry of the material.

Preferably, the first data acquisition system and the second data acquisition system configured to operate on respective samples of the input material and of the output material, to analyze them. In other words, it is not necessary to analyze each and every fragment, but only a significant subset of the output/input material.

Preferably, the mechanical shredding system comprises at least one rotor or more rotors, in a shredding chamber, which has a plurality of tools adapted to shredding the material.

Preferably, the regulation device of the mechanical shredding system, configured to adjust a dimension of the output particles, is mechanically and automatically adjustable or provides at least one manually swappable element. In other words, the control method of the invention allows to optimize the dimensional parameter of the at least one regulation device, which influences a dimension of the output particles. For example, an actual mechanized variation of a distance between sharp tools or a replacement of a grid element with different spacing can be envisaged.

Preferably, at least one of said first transportation system and said second transportation system comprises at least one conveyor belt, which represents the preferred, but non-limiting, embodiment.

Further features and advantages will become clearer from the detailed description given herein below of preferred non-limiting embodiments of the present invention, and from the dependent claims that outline preferred and particularly advantageous embodiments of the invention.

### BRIEF DESCRIPTION OF THE DRAWINGS

The invention is illustrated with reference to the following figures, which are provided by way of non-limiting example, where:

FIG. 1 shows a continuous mechanical shredding apparatus, with control of the feedforward type and, in addition, feedback control.

FIG. 2 shows a flow chart relating to a control method of a continuous mechanical shredding apparatus, which is in particular of the feedforward type with feedback control.

In the different figures, analogous elements will be identified by analogous reference numerals.

### DETAILED DESCRIPTION

In general, cyber-physical systems are integrated systems including a hardware part and a software part that continuously exchange information and actions. The hardware part collects the information through sensors and sends it to the software part, which is capable of processing it through models, meta-models and optimization models. The results are then delivered to the hardware part under the form of optimized commands to perform.

Therefore, the present invention provides a cyber-physical system for mechanical shredding, provided by a continuous mechanical shredding apparatus and also by a corresponding control method.

A general description of the cyber-physical system is given herein.

A transportation system brings the material to be shredded, usually in the form of pieces with dimensions smaller than 10 cm, to a particle dimension analyzer to obtain a dimensional description of the material to be shredded.

Thereafter, the material to be shredded is put into the mechanical shredding machinery, again using a transportation system, through an inlet designated for material supply.

The data collected by the particle dimension analyzer, together with the data inputted by the operator about the dimensional characteristics of the material to be obtained as an output material, are sent to a software designated for the optimization of the shredding process, which produces through an algorithm the information for setting the process parameters of shredding, such as the dimension of dimensional adjustment, the rotation speed and the amount of input material per unit of time.

Then, the material goes into the shredding chamber in which the physical process of shredding by the designated shredding tools occurs.

The shredding machinery and the software exchange information in real time, in this way the process parameters such as the rotation speed and the amount of input material per unit of time are modified in real time.

The output material is then analyzed with a particle dimension analyzer, so as to obtain a dimensional description of the output material. These data are analyzed by the software that will send in real time the information to correct the abovementioned process parameters.

Finally, the shredded material is collected in a designated area.

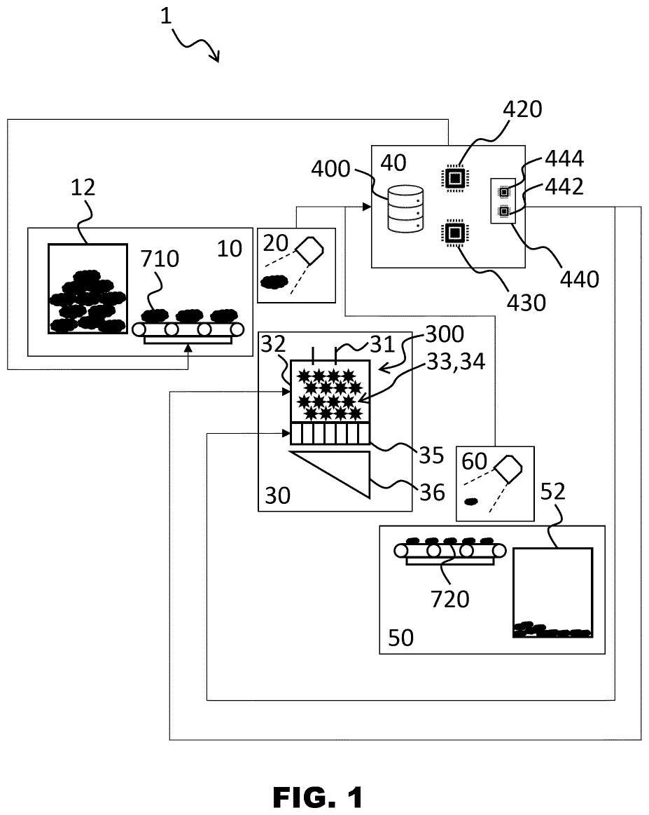

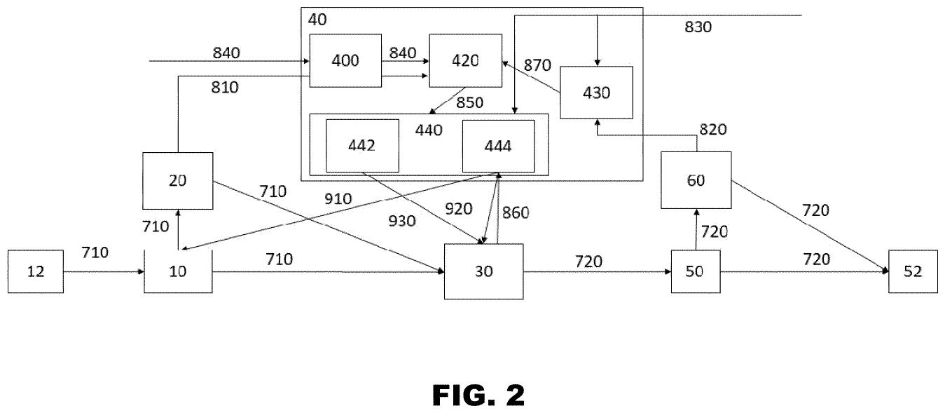

FIG. 1 shows a schematic and exemplary embodiment of a continuous mechanical shredding apparatus, and FIG. 2 shows a flow chart illustrating a control method of a continuous mechanical shredding apparatus.

The continuous mechanical shredding apparatus 1 includes the following subsystems:
a transportation system of the input material 1
a data acquisition system for the input material 20
a shredding system 30
a software system 40
a transportation system of the output material 50
a data acquisition system for the output material 60

The transportation system of the input material 10, which may be a conveyor belt, has the function of transporting the material to be shredded, from a point of collection of the material to be shredded 12, first to the dimension analyzer of the input material 20, and subsequently to the shredder system 30.

By modifying the operation speed with which the material is transported, the flow rate 910 and thus the amount of material occupying the shredding chamber, which influences energy consumption and tool wear, can be modified.

Then, the transportation system of the output material 60, which may also be a conveyor belt, brings the shredded material from the shredding system 30 to the dimension analyzer of the output material 60 and, finally, to an area designated for the collection of the shredded material 52.

The data acquisition system for the input material 20 and the data acquisition system for the output material 60 include a particle dimension analyzer, which, through a camera system, acquires photographs of the particles crossing it and gives as a result information about the dimensional distribution and other morphological characteristics of the particles, including their sphericity and their symmetry.

The shredding system 30 schematically shown in FIG. 1 comprises a mechanical shredder 300 having an opening 31 for material supply, a shredding chamber 32, at least one rotor 33, a plurality of tools 34 adapted to shredding arranged on the at least one rotor 33, a grid 35, a collection box 36.

The shredding system 30 comprises in particular a mechanical shredder 300 that can be, for example, a cutting mill capable of communicating with the software control system 40 through a machine-software communication system. The variable parameters of the mill 300 are the dimension of the grid 35, which influences the dimension of the output particles, and the rotation speed 920, which influences energy consumption and tool wear.

The control system 40 comprises a database 400 containing all the historical information about the data acquired in the previous shredding sessions, about the data of the types of input materials and about the target materials.

The control system 40 comprises a data processing module 420 that, through models and meta-models, predicts the dimensional distribution of the output material with different grids. The algorithm of the data processing model 420 is trained with the data of the database 400 and with the data it receives in real time during the shredding sessions.

The control system 40 comprises a feedback control module 430 that allows to retrain the model in real time.

The control system 40 comprises an optimization module 440 that is divided in two sub-modules 442 and 444 that continuously exchange information and cooperate in a bilateral manner. The module 442 is designated for the optimization of the dimensional distribution of the output particles. The module 444 is designated for the minimization of energy consumption and of wear of the cutting tools in real time.

FIG. 2 shows a flow chart illustrating the functioning of the continuous mechanical shredding apparatus of the present invention, according to the corresponding control method.

In FIG. 2, the following reference numerals indicate:
710 input material
720 output material
810 information about the input material
820 information about the output material
830 information about the target material
840 information about the type of input material
850 prediction of the dimensional distribution
860 energy consumption of the machinery
870 feedback
910 flow rate optimization
920 rotor speed optimization
930 grid optimization
10 transportation system of the input material
12 point of collection of the material to be shredded
20 dimension analyzer of the input material
30 shredding system
40 control system
400 database
420 processing module
430 feedback control module
440 optimization module
442 dimensional optimization module
444 consumption optimization module
50 transportation system of the output material
52 point of collection of the shredded material
60 dimension analyzer of the output material

The input material 710, consisting of intact objects or coarsely ground particles, is taken from a point of collection of the material to be shredded 12 and transported by means of the transportation system 10, a part is passed through the dimension analyzer of the input material 20, which acquires information regarding the dimensional and morphological characteristics of the input particles 810 and send it to the processing module 420 of the software system 40.

The information about the type of input material 840 is given as input to the database 400, or, if said information is already present, it is selected from the available; this information is then passed to the processing module 420 together with the information regarding the dimensional characteristics of the input particles 810, wherein said processing module is capable of providing a prediction of the dimensional distribution of the output material 850 for different grids to the optimization module 440.

The optimization module 440 receives as an input the prediction about the dimensional distribution of the output material 850 and the information about the target material 830 to be obtained; said information is processed by the sub-module designated for the dimensional optimization 442 that selects the most suitable grid 930, which must be modified before beginning shredding.

Once the grid has been selected, the module designated for consumption optimization 444 obtains through an algorithm:
the rotation speed 920 of the mechanical shredding system 30 that optimizes energy consumption and tool wear
the flow rate 910, therefore the speed at which the transportation system of the input material 10 must operate.

The optimized setting is transmitted by a machine-software communication system to the transportation system 10 and to the mechanical shredding system 30 and can be modified in real time.

The material that passed through the input dimension analyzer 20 rejoins, through the transportation system of the input material 10, the input material 710 and is then shredded by the mechanical shredding system 30.

During the shredding process, the mechanical shredding system 30 provides in real time information about energy consumption of the machine 860 to the consumption optimization module 444, so that the model can continuously train and improve the setting 920. The shredded output material 720 is in part transported by a transportation system 50 to a dimension analyzer of the output material 60, which acquires information about the dimensional distribution of the output material 820 and sends it to the feedback control module 430 to let them be compared with the information about the material to be obtained as a target 830. If the difference between the dimensional distribution of the output material 720 and of the target material 830 is lower than a selected value, the shredded output material 720 is transported to a collection area 52. If the difference between the dimensional distribution of the output material 720 and the target dimensional distribution 830 is higher than a selected value, the information of the feedback control 870 is sent to the processing module 420 that uses it to train the algorithm again and, through the dimensional optimization module 442, a new prediction about the distribution of the output material is made and the command to change the grid 930 is given.

### INDUSTRIAL APPLICABILITY

The continuous mechanical shredding apparatus and the corresponding control method, according to the present invention, allow to obtain better performance compared to the use of general guidelines regarding material shredding.

In a shredding example, a production scrap made of fiberglass coming from a company producing bathroom fixture is considered.

Under standard process conditions, that are assumed as an indication, to obtain a material within the specification (with dimension between 1.5 and 2.5 mm), according to the general guidelines the grid dimension is 2 mm and the rotation speed is 3000 rpm; in this case, an amount of material with specific dimension, reusable for the objects of interest, is obtained, said amount depending on the amount of input material.

Under conditions optimized according to the present invention, to obtain the same material within the specification, a grid dimension of 4 mm and a rotation speed of 1200 rpm are obtained; in this case, an amount of material with specific dimension, reusable for the objects of interest, that is 3 times higher than the amount obtainable without the invention is obtained, considering the same amount of input material.

It should be noted that, thanks to the present invention, the amount of reusable material is 3 times higher and, therefore, waste (and related costs) considerably decreases.

The present invention may find non-exclusive application in the field thermosetting polymer matrix fiberglass.

Considering the description reported herein, a person skilled in the art can devise further modifications and variants, for the purpose of satisfying specific and particular requirements.

For example, different shredding technologies and general shredding plant configurations may be provided.

Moreover, for example, it is possible to apply a control method to a preexisting mechanical shredding apparatus, by means of specific sensors and processing means for the control system, at least partially assigning some adjustments of the process to a human operator.

The embodiments described herein are thus to be understood as non-limiting examples of the invention.

1. A continuous mechanical shredding apparatus comprising:
a first transportation system of input material, for a material to be shredded,
a first data acquisition system for said input material, configured to analyze at least one first dimension of said input material,
a mechanical shredding system comprising moving tools to shred said input material and further comprising at least one regulation device configured to adjust a dimension of output particles from said mechanical shredding system,
a control system operatively associated with elements of said mechanical shredding apparatus,
a second transportation system of output material, for a material shredded by said mechanical shredding system,
a second data acquisition system for said output material, configured to analyze at least one second dimension of said output material,
wherein said control system is configured to receive said at least one first dimension of said input material and said at least one second dimension of said output material,
and wherein said control system is further configured to automatically determine process parameters including:
an operation speed of said first transportation system to modify a flow rate of said input material,
at least one dimensional parameter of said at least one regulation device (35),
at least one rotation speed of said moving tools,
said control system being adapted to optimize said process parameters according to a target for said at least one second dimension of said output material.

2. The continuous mechanical shredding apparatus according to claim 1, said control system being adapted to determine said process parameters according to a real-time training considering said at least one first dimension of said input material and said at least one second dimension of said output material.

3. The continuous mechanical shredding apparatus according to claim 1, wherein said control system comprises a database adapted to store previously acquired historical data, and comprises a data processing module making a data processing algorithm trained with said historical data.

4. The continuous mechanical shredding apparatus according to claim 3, wherein said control system further comprises a feedback control module adapted to verify a dimensional compliance of said at least one second dimension with a target dimension and to further train said processing algorithm according to data collected in real time by said first data acquisition system and said second data acquisition system.

5. The continuous mechanical shredding apparatus according to claim 3, wherein said control system further comprises an optimization module configured to optimize said second dimension of said output material and further configured to minimize an energy requirement of said mechanical shredding system and wear of said moving tools.

6. The continuous mechanical shredding apparatus according to claim 1, wherein said control system is further adapted to automatically adjust said operation speed of said first transportation system, said at least one dimensional parameter of said at least one regulation device, and said at least one rotation speed of said moving tools.

7. The continuous mechanical shredding apparatus according to claim 1, said first data acquisition system and said second data acquisition system comprise at least one image acquisition system configured to determine at least a dimensional distribution of a material framed in an image.

8. The continuous mechanical shredding apparatus according to claim 1, said first data acquisition system and said second data acquisition system are further configured to analyze further morphological characteristics of said input material and of said output material.

9. The continuous mechanical shredding apparatus according to claim 1, wherein said morphological characteristics include shape and/or sphericity and/or symmetry.

10. The continuous mechanical shredding apparatus according to claim 1, wherein said mechanical shredding system comprises at least one rotor in a shredding chamber, said at least one rotor being associated with a plurality of tools adapted to shredding.

11. The continuous mechanical shredding apparatus according to claim 1, wherein said regulation device comprises a grid element having adjustable spacing and/or at least one manually swappable element.

12. The continuous mechanical shredding apparatus according to claim 1, wherein said regulation device is mechanically and automatically adjustable and provides for a regulation of a distance between said moving tools.

13. The continuous mechanical shredding apparatus according to claim 1, wherein said first transportation system and/or said second transportation system comprise at least one conveyor belt.

14. A control method of a continuous mechanical shredding apparatus, said continuous mechanical shredding apparatus comprising:
a first transportation system of input material for a material to be shredded,
a first data acquisition system for said input material,
a mechanical shredding system comprising moving tools to shred said input material, and further comprising at least one regulation device configured to adjust a dimension of output particles from said mechanical shredding system,
a second transportation system of output material, for a material shredded by said mechanical shredding system,
a second data acquisition system for said output material,
said control method comprising:
analyzing at least one first dimension of said input material by said first data acquisition system,
analyzing at least one second dimension of said output material by said second data acquisition system,
determining process parameters including:
an operation speed of said first transportation system to modify a flow rate of said input material;
a dimensional parameter of said at least one regulation device;
at least one rotation speed of said moving tools,
wherein said process parameters are optimized according to a target for said at least one second dimension of said output material.

15. The control method according to claim 14, adapted to be provided in a continuous mechanical shredding apparatus.

16. A continuous mechanical shredding apparatus, comprising:
a first transportation system of input material to be shredded,
a first data acquisition system of said input material for analyzing at least one first dimension of said input material,
moving tools in said mechanical shredding apparatus to shred said input material,
at least one regulation device configured to adjust the dimension of output particles from said mechanical shredding apparatus,
a control system operatively associated with elements of said mechanical shredding apparatus,
a second transportation system for outputting material shredded by said mechanical shredding apparatus,
a second data acquisition system of said output material for analyzing at least one second dimension of said output material,
wherein said control system is configured to receive said at least one first dimension of said input material and said at least one second dimension of said output material and to automatically determine process parameters including:
an operation speed of said first transportation system to modify a flow rate of said input material,
at least a dimensional parameter of said at least one regulation device,
at least one rotation speed of said moving tools,
said control system being adapted to optimize said process parameters according to a target for said at least one second dimension of said output material.

17. The continuous mechanical shredding apparatus according to claim 16, wherein said regulation device is mechanically and automatically adjustable and provides for a regulation of a distance between said moving tools.

18. The continuous mechanical shredding apparatus according to claim 16, wherein said first data acquisition system and said second data acquisition system comprise at least one image acquisition system configured to determine at least a dimensional distribution of a material framed in an image.
